(19) United States
(12) Patent Application Publication
(10) Pub. No.: US 2014/0154028 A1
(43) Pub. Date: Jun. 5, 2014

(54) Scisssors type expansion bolt

(71) Applicants: Zhisheng Pei, Zhenjiang City (CN); Chunguang Pei, Zhenjiang City (CN); Xiuxiu Wang, Zhenjiang City (CN)

(72) Inventors: Zhisheng Pei, Zhenjiang City (CN); Chunguang Pei, Zhenjiang City (CN); Xiuxiu Wang, Zhenjiang City (CN)

(73) Assignee: Chunguang Pei, Zhenjiang City, Jiangsu (CN)

(21) Appl. No.: 14/234,638

(22) PCT Filed: Aug. 1, 2012
(86) PCT No.: PCT/CN2012/079504

§ 371 Date: Jan. 24, 2014

(30) Foreign Application Priority Data
Aug. 2, 2011 (CN) 201110218903.3
Oct. 26, 2011 (CN) 201110328872.7
Feb. 21, 2012 (CN) 201210038507.7
May 16, 2012 (CN) 201210150902.4

(51) Int. Cl. F16B 13/08

(52) U.S. Cl. CPC F16B 13/0808
USPC 411/345

(57) ABSTRACT

A scissors type expansion bolt is provided with a threaded bolt; two bars each including a concave jaw put on the threaded bolt; a pivot driven through intermediate portions of the bars and one end of the threaded bolt to pivotably secure the bars and the threaded bolt together; a threaded fastener put on an other end of the threaded bolt; and a sleeve put on the threaded bolt and disposed between the bars and the nut. In response to rotating the threaded fastener toward the bars, the sleeve opens the bars.

### BACKGROUND OF THE INVENTION

1. Field of the Invention

The invention relates to expansion bolts and more particularly to a scissors type expansion bolt.

2. Description of Related Art

Expansion bolts secure themselves using a mechanical wedging effect at the end of the fastener. Tightening the bolt may result in a wedge being driven up against a sleeve. This jams the end of the bolt, and provides the strength. Conventional expansion bolts have an anchor bolt provided with a screw thread at a rear end and an expansion cone at a front end. The anchor bolt and the expansion cone are referred to as the basic anchor part. An expansion sleeve, which is divided into expansion portions by means of longitudinal slits, is mounted on the anchor bolt. The expansion sleeve is expanded as a result of being pushed up on the expansion cone. As a result, it anchors the expansible anchor in a drilled hole.

However, the conventional expansion bolts are disadvantageous because they are complicated and thus expensive to manufacture. It is further disadvantageous that expansion is brought about by screwing on and tightening the nut on the screw thread of the anchor bolt. This is time-consuming. Thus, the need for improvement still exists.

### SUMMARY OF THE INVENTION

It is therefore one object of the invention to provide an expansion bolt comprising a threaded bolt; two bars each including a concave jaw put on the threaded bolt; a pivot driven through intermediate portions of the bars and one end of the threaded bolt to pivotably secure the bars and the threaded bolt together; a threaded fastener put on an other end of the threaded bolt; and a sleeve put on the threaded bolt and disposed between the bars and the nut; wherein in response to rotating the threaded fastener toward the bars, the sleeve opens the bars.

Preferably, the concave jaw has a half-circular section.

Preferably, the concave jaw further comprises an inclined surface on an edge.

Preferably, the sleeve comprises a truncated conic member at one end adjacent to the pivot.

Preferably, the truncated conic member engages the bars.

Preferably, an inclined angle of the inclined surface is equal to that of a lateral surface of the truncated conic member.

Preferably, the threaded fastener comprises a washer put on the threaded bolt and disposed at the other end of the sleeve, and a resilient ring put on the threaded bolt and engaged the washer.

Preferably, further comprises a biasing member interconnecting ones ends of the bars.

Preferably, the threaded bolt comprises a convex end engaging the bars.

Preferably, the truncated conic member rides along the inclined surfaces to open the bars.

Preferably, further comprises a cone formed with the bars.

Preferably, each of the bars comprises two through holes at both ends respectively.

The above and other objects, features and advantages of the invention will become apparent from the following detailed description taken with the accompanying drawings.

### BRIEF DESCRIPTION OF THE DRAWINGS

FIG. 1 is a side elevation of an expansion bolt according to a first preferred embodiment of the invention;

FIG. 2 is another side elevation of the expansion bolt;

FIG. 3 is a view similar to FIG. 1 showing the scissors mechanism being opened by driving the nut upward along the bolt;

FIG. 4 is a side elevation of an expansion bolt according to a second preferred embodiment of the invention;

FIG. 5 is another side elevation of the expansion bolt of FIG. 4;

FIG. 6 is a view similar to FIG. 4 showing the scissors mechanism being opened by driving the bolt upward;

FIG. 7 is a side elevation of an expansion bolt according to a third preferred embodiment of the invention;

FIG. 8 is another side elevation of the expansion bolt of FIG. 7;

FIG. 9 is a view similar to FIG. 7 showing the scissors mechanism being opened by driving the nut upward along the bolt;

FIG. 10 is a side elevation of an expansion bolt according to a fourth preferred embodiment of the invention;

FIG. 11 is another side elevation of the expansion bolt of FIG. 10;

FIG. 12 is a view similar to FIG. 10 showing the scissors mechanism being opened by driving the bolt upward;

FIG. 13 is a side elevation of an expansion bolt according to a fifth preferred embodiment of the invention, where the scissors mechanism being opened;

FIG. 14 is a side elevation of an expansion bolt according to a sixth preferred embodiment of the invention, where the scissors mechanism being opened;

FIG. 15 is a side elevation of an expansion bolt according to a seventh preferred embodiment of the invention, where the scissors mechanism being opened;

FIG. 16 is a side elevation of an expansion bolt according to an eighth preferred embodiment of the invention;

FIG. 17 is another side elevation of the expansion bolt of FIG. 16;

FIG. 18 is a view similar to FIG. 16 showing the scissors mechanism being opened by driving the bolt upward;

FIG. 19 is a side elevation of an expansion bolt according to a ninth preferred embodiment of the invention;

FIG. 20 is a view similar to FIG. 19 showing the scissors mechanism being opened by driving the bolt upward;

FIG. 21 is a side elevation of an expansion bolt according to a tenth preferred embodiment of the invention;

FIG. 22 is another side elevation of the expansion bolt of FIG. 21;

FIG. 23 is a view similar to FIG. 21 showing the scissors mechanism being opened by driving the bolt upward;

FIG. 24 is a side elevation of an expansion bolt according to an eleventh preferred embodiment of the invention showing the scissors mechanism being opened by driving the bolt upward; and

FIG. 25 is a side elevation of an expansion bolt according to a twelfth preferred embodiment of the invention showing the scissors mechanism being opened by driving the bolt upward.

### DETAILED DESCRIPTION OF THE INVENTION

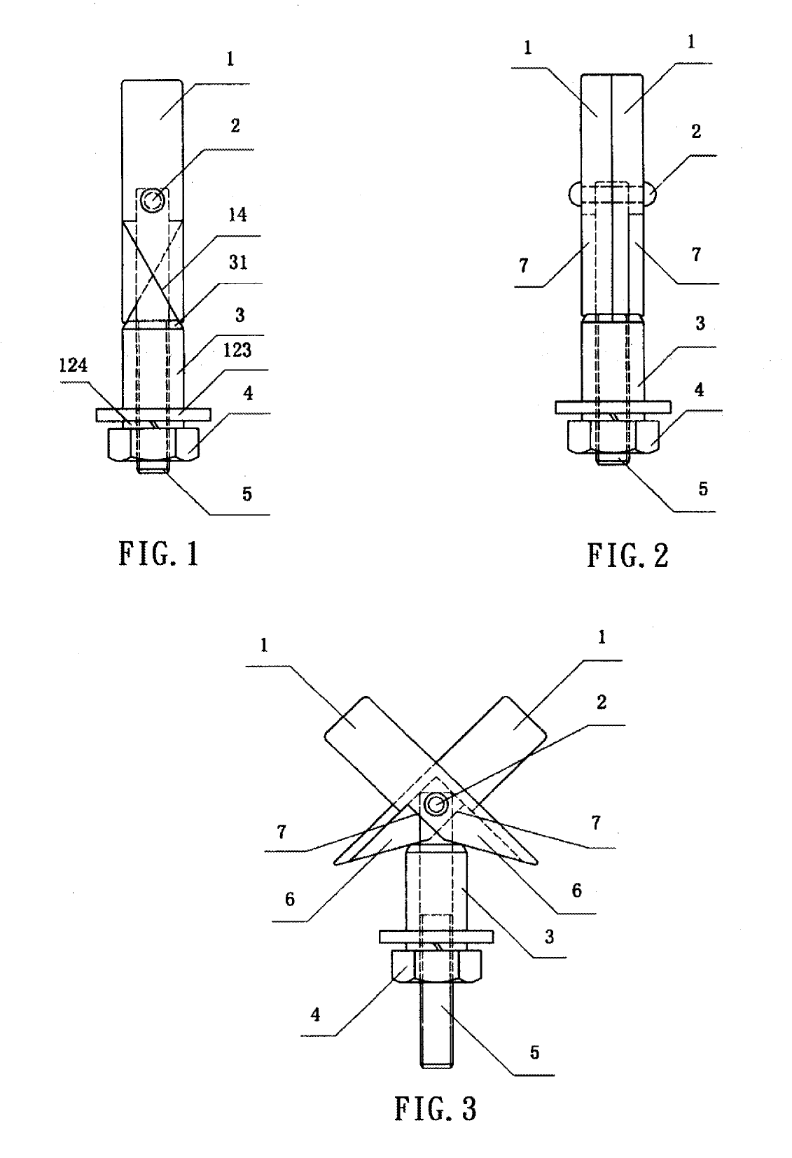

Referring to FIGS. 1 to 3, an expansion bolt in accordance with a first preferred embodiment of the invention comprises the following components as discussed in detail below.

Two bars 1 are joined by an intermediate pivot 2 to form a scissors mechanism. Each bar 1 comprises a concave jaw 6 of half-circular section having an opening 7. An inclined surface 14 is formed on an edge of the concave jaw 6. A threaded bolt 5 has one end being inserted by the pivot 2. A sleeve 3 is put on the bolt 5 and comprises a truncated conic end 31 adjacent to the pivot 2. The inclined angle of the inclined surface 14 is the same as that of the truncated conic end 31. The inclined surface 14 has one end engaged the truncated conic end 31. A washer 123 is put on the bolt 5 and is disposed at the other end of the sleeve 3. A resilient ring 124 is put on the bolt 5 and is disposed at a bottom of the washer 123. A threaded fastener 4 is threadedly put on the bolt 5 to urge both the ring 124 and the washer 123 against the sleeve 3.

In use, an individual may rotate the threaded fastener 4 to push the ring 124, the washer 123, and the sleeve 3 upward. And in turn, the truncated conic end 31 rides along the inclined surfaces 14 to open the scissors mechanism until the pushing is stopped. The open scissors mechanism thus is fastened in, for example, concrete. Therefore, the expansion bolt is fixed and can be used to attach an object to the concrete.

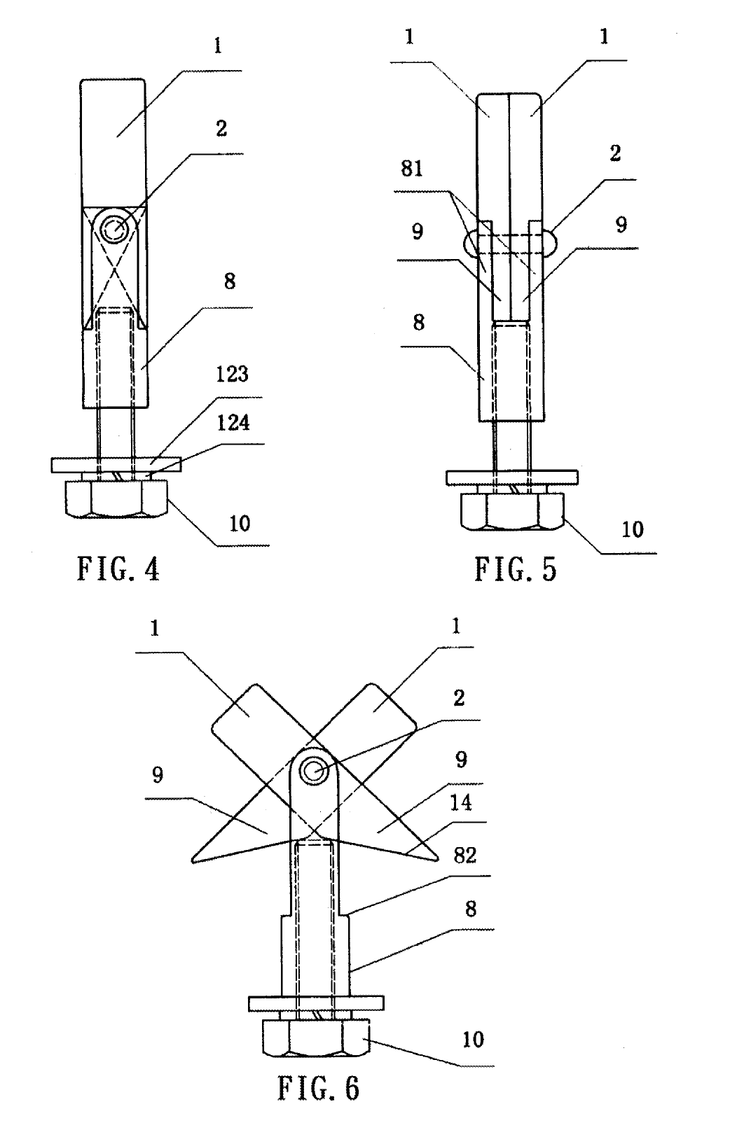

Referring to FIGS. 4 to 6, an expansion bolt in accordance with a second preferred embodiment of the invention is shown. The characteristics of the second preferred embodiment are substantially the same as that of the first preferred embodiment except the following:

Two bars 1 are joined by an intermediate pivot 2 to form a scissors mechanism. Each bar 1 comprises an extension 9 with the pivot 2 inserted through. An inclined surface 14 is formed on an edge of the extension 9. A threaded bolt and nut combination 10 is provided. An internally threaded sleeve 8 is put on the bolt and nut combination 10 and comprises two opposite projections 81 with the pivot 2 inserted through, and an intermediate shoulder 82. The extensions 9 are disposed in a gap between the projections 81 and have one open ends rested upon the sleeve 8. A resilient ring 124 is put on the nut of the bolt and nut combination 10. A washer 123 is put on the bolt and nut combination 10 and is disposed on the ring 124.

In use, an individual may rotate the bolt and nut combination 10 to push both the ring 124 and the washer 123 upward. And in turn, one end of the bolt and nut combination 10 rides along the inclined surfaces 14 to open the extensions 9 (i.e., the scissors mechanism) until the pushing is stopped. The original position of the extensions 9 is occupied by a portion of the bolt and nut combination 10. The open scissors mechanism thus is fastened in, for example, concrete. Therefore, the expansion bolt is fixed and can be used to attach an object to the concrete.

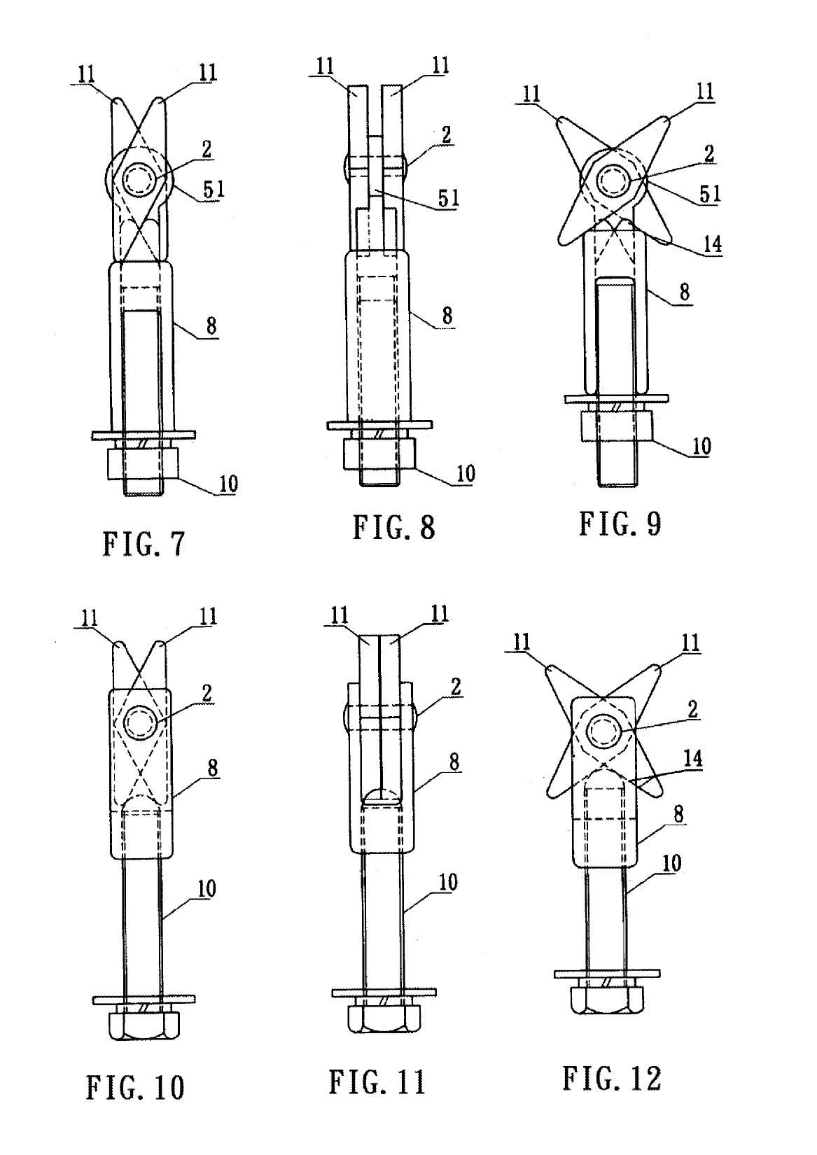

Referring to FIGS. 7 to 9, an expansion bolt in accordance with a third preferred embodiment of the invention is shown. The characteristics of the third preferred embodiment are substantially the same as that of the second preferred embodiment except the following:

Two parallel bars 11 are joined by an intermediate pivot 2 to form a scissors mechanism. A ring-shaped spacer 51 is provided between the bars 11 with the pivot 2 inserted through. An inclined surface 14 is formed on an edge of a half portion of the bar 11. A bolt and nut combination 10 is provided. An internally threaded sleeve 8 is put on the bolt and nut combination 10 and comprises two opposite projections (not numbered) disposed in a gap between one half of one bar 11 and one half of the other bar 11. The bars 11 are engaged with a shoulder of the sleeve 8. A resilient ring (not numbered) is put on the nut of the bolt and nut combination 10. A washer (not numbered) is put on the bolt and nut combination 10 and is disposed on the ring.

In use, an individual may rotate the bolt and nut combination 10 to push both the ring and the washer upward. And in turn, one end of the bolt and nut combination 10 rides along the inclined surfaces 14 to open the bars 11 (i.e., the scissors mechanism) until the pushing is stopped. The open scissors mechanism thus is fastened in, for example, concrete. Therefore, the expansion bolt is fixed and can be used to attach an object to the concrete.

Referring to FIGS. 10 to 12, an expansion bolt in accordance with a fourth preferred embodiment of the invention is shown. The characteristics of the fourth preferred embodiment are substantially the same as that of the third preferred embodiment except the following:

Two parallel bars 11 are joined by an intermediate pivot 2 to form a scissors mechanism. The bars 11 are engaged. An inclined surface 14 is formed on an edge of a half portion of the bar 11. A bolt and nut combination 10 is provided. An internally threaded sleeve 8 is partially put on the bolt and nut combination 10 and comprises two opposite projections (not numbered) with the pivot 2 inserted through. The bars 11 are partially disposed between the projections of the sleeve 8 and is engaged with a convex end of the bolt and nut combination 10. A resilient ring (not numbered) is put on the nut of the bolt and nut combination 10. A washer (not numbered) is put on the bolt and nut combination 10 and is disposed on the ring.

In use, an individual may rotate the bolt and nut combination 10 to push both the ring and the washer upward. And in turn, the convex end of the bolt and nut combination 10 rides along the inclined surfaces 14 to open the bars 11 (i.e., the scissors mechanism) until the pushing is stopped. The open scissors mechanism thus is fastened in, for example, concrete. As a result, the expansion bolt is fixed and can be used to attach an object to the concrete.

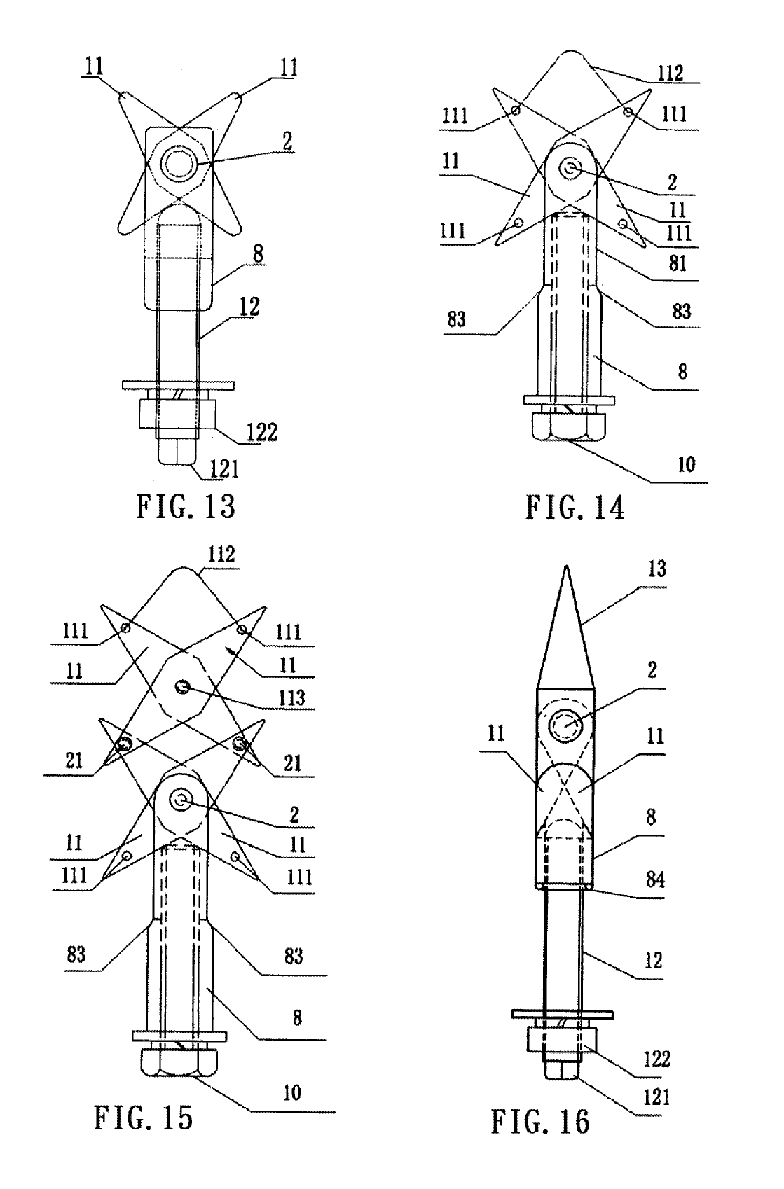

Referring to FIG. 13, an expansion bolt in accordance with a fifth preferred embodiment of the invention is shown. The characteristics of the fifth preferred embodiment are substantially the same as that of the fourth preferred embodiment except the following:

Two parallel bars 11 are joined by an intermediate pivot 2 to form a scissors mechanism. The bars 11 are engaged. An inclined surface (not numbered) is formed on an edge of a half portion of the bar 11. A bolt and nut combination 12 is provided. An internally threaded sleeve 8 is partially put on the bolt and nut combination 12 and comprises two opposite projections (not numbered) with the pivot 2 inserted through. The bars 11 are partially disposed between the projections of the sleeve 8 and are engaged with a convex end of the bolt and nut combination 12. A resilient ring (not numbered) is put on the nut of the bolt and nut combination 12. A washer (not numbered) is put on the bolt and nut combination 12 and is disposed on the ring. The bolt and nut combination 12 comprises a hexagonal end 121 and a nut 122.

In use, an individual may rotate the nut 122 of the bolt and nut combination 12 to push both the ring and the washer upward. And in turn, the convex end of the bolt and nut combination 12 rides along the inclined surfaces to open the bars 11 (i.e., the scissors mechanism) until the pushing is stopped. The open scissors mechanism thus is fastened in, for example, concrete. Therefore, the expansion bolt is fixed and can be used to attach an object to the concrete.

Referring to FIG. 14, an expansion bolt in accordance with a sixth preferred embodiment of the invention is shown. The characteristics of the sixth preferred embodiment are substantially the same as that of the fifth preferred embodiment except the following:

Two parallel bars 11 are joined by an intermediate pivot 2 to form a scissors mechanism. The bars 11 are engaged. An inclined surface (not numbered) is formed on an edge of a half portion of the bar 11. A through hole 111 is provided at an end of either half of the bar 11. A spring 112 has two ends fastened at the through holes 111 of the upper halves of the bars 11. A bolt and nut combination 10 is provided. An internally threaded sleeve 8 is partially put on the bolt and nut combination 10 and comprises two opposite projections 81 with the pivot 2 inserted through, and two intermediate, opposite shoulders 83. The bars 11 are partially disposed between the projections 81 of the sleeve 8 and are engaged with an end of the bolt and nut combination 10. A resilient ring (not numbered) is put on the nut of the bolt and nut combination 10. A washer (not numbered) is put on the bolt and nut combination 10 and is disposed on the ring.

In use, an individual may rotate the nut of the bolt and nut combination 10 to push both the ring and the washer upward. And in turn, the convex end of the bolt and nut combination 10 rides along the inclined surfaces to open the bars 11 (i.e., the scissors mechanism) with the spring 112 being expanded until the pushing is stopped. The open scissors mechanism thus is fastened in, for example, concrete. Therefore, the expansion bolt is fixed and can be used to attach an object to the concrete.

Referring to FIG. 15, an expansion bolt in accordance with a seventh preferred embodiment of the invention is shown. The characteristics of the seventh preferred embodiment are substantially the same as that of the sixth preferred embodiment except the following:

Two parallel first bars 11 are joined by an intermediate pivot 2 to form a scissors mechanism. The first bars 11 are engaged. An inclined surface (not numbered) is formed on an edge of a half portion of the first bar 11. A through hole 11 is provided at an end of either half of the first bar 11. Two parallel second bars 11 are joined by an intermediate pivot 113 to form a scissors mechanism. The second bars 11 are engaged. A through hole 111 is provided at an end of either half of the second bar 11. Two second pivots 21 each are disposed through the upper through hole 111 of the second bar 11 and the lower through hole 111 of the first bar 11 respectively. Thus, the first and second bars 11 are pivotably secured together. A spring 112 has two ends fastened at the through holes 11 of the upper halves of the second bars 11. A bolt and nut combination 10 is provided. An internally threaded sleeve 8 is partially put on the bolt and nut combination 10 and comprises two opposite projections (not numbered) with the pivot 2 inserted through, and two intermediate, opposite shoulders 83. The first bars 11 are partially disposed between the projections of the sleeve 8 and is engaged with an end of the bolt and nut combination 10. A resilient ring (not numbered) is put on the nut of the bolt and nut combination 10. A washer (not numbered) is put on the bolt and nut combination 10 and is disposed on the ring.

In use, an individual may rotate the nut of the bolt and nut combination 10 to push both the ring and the washer upward. And in turn, the end of the bolt and nut combination 10 rides along the inclined surfaces to open the first bars 11 (i.e., the scissors mechanism) with the spring 112 being expanded until the pushing is stopped. The open scissors mechanism thus is fastened in, for example, concrete. Therefore, the expansion bolt is fixed and can be used to attach an object to the concrete.

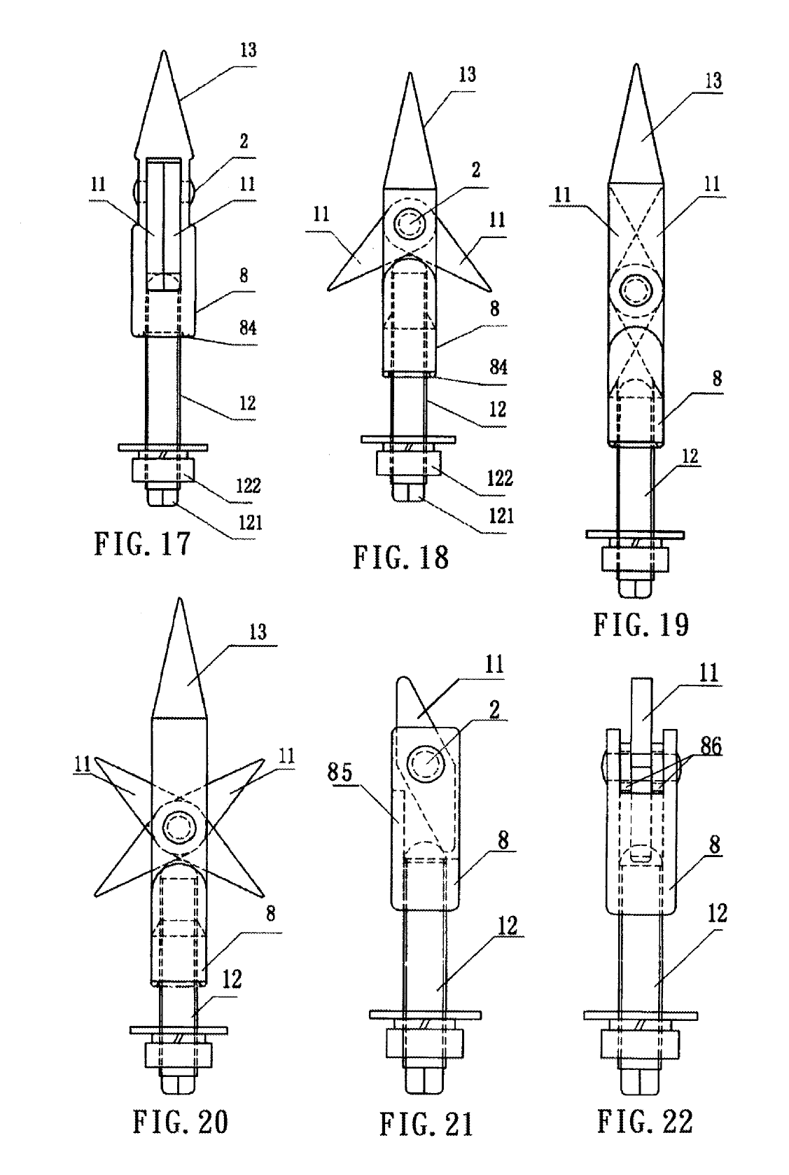

Referring to FIGS. 16 to 18, an expansion bolt in accordance with an eighth preferred embodiment of the invention is shown. The characteristics of the eighth preferred embodiment are substantially the same as that of the seventh preferred embodiment except the following:

Two parallel bars 11 are joined by an intermediate pivot 2 to form a scissors mechanism. The bars 11 are engaged. A cone 13 is integrally formed with tops of the bars 11. An inclined surface (not numbered) is formed on an edge of a half portion of the bar 11. A bolt and nut combination 12 is provided. An internally threaded sleeve 8 is partially put on the bolt and nut combination 12 and comprises two opposite projections (not numbered) with the pivot 2 inserted through. The bars 11 are partially disposed between the projections of the sleeve 8 and are engaged with a convex end of the bolt and nut combination 12. A resilient ring (not numbered) is put on the nut of the bolt and nut combination 12. A washer (not numbered) is put on the bolt and nut combination 12 and is disposed on the ring. The bolt and nut combination 12 comprises a hexagonal end 121 and a nut 122.

In use, an individual may rotate the bolt and nut combination 12 to push both the ring and the washer upward. And in turn, the convex end of the bolt and nut combination 12 rides along the inclined surfaces to open the bars 11 (i.e., the scissors mechanism) until the pushing is stopped. The open scissors mechanism thus is fastened in, for example, concrete with the additional help of the cone 13. As a result, the expansion bolt is fixed and can be used to attach an object to the concrete.

Referring to FIGS. 19 and 20, an expansion bolt in accordance with a ninth preferred embodiment of the invention is shown. The characteristics of the ninth preferred embodiment are substantially the same as that of the eighth preferred embodiment except the following:

Two parallel bars 11 are joined by an intermediate pivot (not numbered) to form a scissors mechanism. The bars 11 are engaged. A cone 13 has a lower portion inserted through by the pivot. An inclined surface (not numbered) is formed on an edge of a half portion of the bar 11. A bolt and nut combination 12 is provided. An internally threaded sleeve 8 is partially put on the bolt and nut combination 12 and comprises two opposite projections (not numbered). The bottom of the cone 13 is engaged with a convex end of the bolt and nut combination 12. A resilient ring (not numbered) is put on the nut of the bolt and nut combination 12. A washer (not numbered) is put on the bolt and nut combination 12 and is disposed on the ring.

In use, an individual may rotate the bolt and nut combination 12 to push both the ring and the washer upward. And in turn, the convex end of the bolt and nut combination 12 rides along the inclined surfaces to open the bars 11 (i.e., the scissors mechanism) until the pushing is stopped. The open scissors mechanism thus is fastened in, for example, concrete with the additional help of the cone 13. As a result, the expansion bolt is fixed and can be used to attach an object to the concrete.

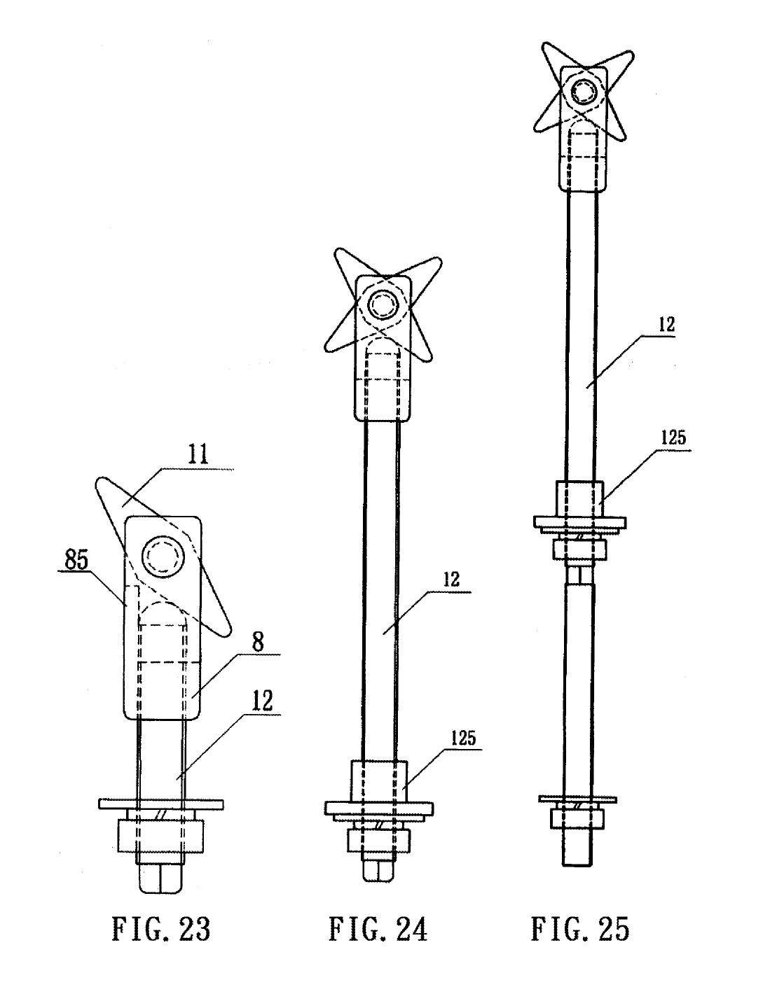

Referring to FIGS. 21 to 23, an expansion bolt in accordance with a tenth preferred embodiment of the invention is shown. The characteristics of the tenth preferred embodiment are substantially the same as that of the ninth preferred embodiment except the following:

An internally threaded sleeve 8 is partially put on a bolt and nut combination 12 and comprises two opposite projections (not numbered) and a block member 85 formed between one sides of the projections. A pivot 2 is inserted through the projections and a bar 11 which is disposed between the projections in a spaced manner. An inclined surface (not numbered) is formed on an edge of a half portion of the bar 11. A resilient ring (not numbered) is put on the nut of the bolt and nut combination 12. A washer (not numbered) is put on the bolt and nut combination 12 and is disposed on the ring. The sleeve 8 further comprises two spacers 86 each disposed between the bar 11 and the projection of the sleeve 8.

In use, an individual may rotate the bolt and nut combination 12 to push both the ring and the washer upward. And in turn, a convex end of the bolt and nut combination 12 rides along the inclined surface of the bar 11 to pivot the bar 11 until the pushing is stopped. The bar 11 is fastened in, for example, concrete. As a result, the expansion bolt is fixed and can be used to attach an object to the concrete.

Referring to FIG. 24, an expansion bolt in accordance with an eleventh preferred embodiment of the invention is shown. The characteristics of the eleventh preferred embodiment are substantially the same as that of the tenth preferred embodiment except the following:

Two parallel bars (not numbered) are joined by an intermediate pivot (not numbered) to form a scissors mechanism. An inclined surface (not numbered) is formed on an edge of a half portion of the bar. A bolt and nut combination 12 is provided and comprises a nut 125. An internally threaded sleeve (not numbered) is partially threadedly secured to an upper portion of the bolt and nut combination 12. A resilient ring (not numbered) is put on the nut of the bolt and nut combination 12. A washer (not numbered) is put on the bolt and nut combination 12 and is disposed on the ring.

In use, an individual may rotate the bolt and nut combination 12 to push both the ring and the washer upward. And in turn, a convex end of the bolt and nut combination 12 rides along the inclined surfaces to open the bars (i.e., the scissors mechanism) until the pushing is stopped. The open scissors mechanism thus is fastened in, for example, concrete. Therefore, the expansion bolt is fixed and can be used to attach an object to the concrete.

Referring to FIG. 25, an expansion bolt in accordance with a twelfth preferred embodiment of the invention is shown. The characteristics of the twelfth preferred embodiment are substantially the same as that of the eleventh preferred embodiment except the following:

Two parallel bars (not numbered) are joined by an intermediate pivot (not numbered) to form a scissors mechanism. An inclined surface (not numbered) is formed on an edge of a half portion of the bar. A bolt and nut combination 12 is provided and comprises a nut 125. An internally threaded sleeve (not numbered) is partially threadedly secured to an upper portion of the bolt and nut combination 12. A resilient ring (not numbered) is put on the nut of the bolt and nut combination 12. A washer (not numbered) is put on the bolt and nut combination 12 and is disposed on the ring. Further, an extension (not numbered) is formed at one end of the bolt and nut combination 12.

In use, an individual may rotate the bolt and nut combination 12 to push both the ring and the washer upward. And in turn, a convex end of the bolt and nut combination 12 rides along the inclined surfaces to open the bars (i.e., the scissors mechanism) until the pushing is stopped. The open scissors mechanism thus is fastened in, for example, concrete. Therefore, the expansion bolt is fixed and can be used to attach an object to the concrete.

Although the invention has been described in detail, it is to be understood that this is done by way of illustration only and is not to be taken by way of limitation. The scope of the invention is to be limited only by the appended claims.

What is claimed is:

1. An expansion bolt comprising:
a threaded bolt;
two bars each including a concave jaw put on the threaded bolt;
a pivot driven through intermediate portions of the bars and one end of the threaded bolt to pivotably secure the bars and the threaded bolt together;
a threaded fastener put on an other end of the threaded bolt; and
a sleeve put on the threaded bolt and disposed between the bars and the nut;
wherein in response to rotating the threaded fastener toward the bars, the sleeve opens the bars.

2. The expansion bolt of claim 1, wherein the concave jaw has a half-circular section.

3. The expansion bolt of claim 1, wherein the concave jaw further comprises an inclined surface on an edge.

4. The expansion bolt of claim 3, wherein the sleeve comprises a truncated conic member at one end adjacent to the pivot.

5. The expansion bolt of claim 4, wherein the truncated conic member engages the bars.

6. The expansion bolt of claim 3, wherein an inclined angle of the inclined surface is equal to that of a lateral surface of the truncated conic member.

7. The expansion bolt of claim 1, wherein the threaded fastener comprises a washer put on the threaded bolt and disposed at an other end of the sleeve, and a resilient ring put on the threaded bolt and engaged the washer.

8. The expansion bolt of claim 1, further comprising a biasing member interconnecting ones ends of the bars.

9. The expansion bolt of claim 1, wherein the threaded bolt comprises a convex end engaging the bars.

10. The expansion bolt of claim 3, wherein the truncated conic member rides along the inclined surfaces to open the bars.

11. The expansion bolt of claim 1, further comprising a cone formed with the bars.

12. The expansion bolt of claim 11, wherein each of the bars comprises two through holes at both ends respectively.
